(19) United States
(12) Patent Application Publication
(10) Pub. No.: US 2011/0281371 A1
(43) Pub. Date: Nov. 17, 2011

(54) SENSOR AND ANALYSIS FOR FAT METABOLISM BYPRODUCTS

(75) Inventors: R. Aaron Falk, Newcastle, WA (US); Eric Fogel, Seattle, WA (US); Tram Pham, Renton, WA (US)

(73) Assignee: Emergent Detection, Inc., Olympia, WA (US)

(21) Appl. No.: 13/113,045

(22) Filed: May 21, 2011

Related U.S. Application Data
(63) Continuation-in-part of application No. 12/139,259, filed on Jun. 13, 2008.
(60) Provisional application No. 61/347,310, filed on May 21, 2010.

(51) Int. Cl. G01N 21/78

(52) U.S. Cl. 436/169; 422/82.05

(57) ABSTRACT

Systems and methods for detection of human fat metabolism byproducts and analysis of the detection for optimizing dietary results. The present invention includes a compact opto-electronic based sensor to significantly increase (factor of 20 or more) the accuracy and minimal detection limits for a standard ketone test strip.

### PRIORITY CLAIM

This application claims priority to U.S. Provisional Patent Application No. 61/347,310, filed May 21, 2010, which is incorporated herein by reference. This application is a Continuation-in-Part of U.S. patent application Ser. No. 12/139,259 filed Jun. 13, 2008, which is incorporated herein by reference.

### BACKGROUND OF THE INVENTION

The connection between generation of ketones, specifically acetoacetate and b-hydroxybutyrate, in the blood and urine and the utilization of body fat is well established. It is also well known that certain reagents such as nitroprusside will change color in the presence of ketones, which proves to be a useful color indicator.

In U.S. Pat. No. 5,260,291, Fritz suggests the use of standard nitroprusside test strips along with standard nitrogen test strips as a dietary aid—specifically to determine the amount of fat metabolism in a weight loss program. However, Gupta in U.S. Pat. No. 6,762,035 indicates that these strips primarily measure acetoacetate and not b-hydroxybutyrate. The data presented by Gupta suggests that the measurement of acetoacetate alone is not sufficient and that a test strip must be modified to also measure b-hydroxybutyrate to be of use.

Allen, et al. in U.S. Pat. No. 7,364,551 suggests use of a portable electro-chemical device for measuring ketones in the breath. However, breath analysis is highly complex and is easily fooled by byproducts of oral bacteria and dietary intake.

The difficulty of both Fritz's and Gupta's approach is that they rely on “by eye” comparison of strip color changes to a color chart. Such comparisons are extremely subjective. Issues occur with the user being all or partially color blind and baseline color of the urine sample. Moreover the color is changing dynamically (manufacture suggests reading at 20 seconds after urine application). These issues led to highly inaccurate results and severe limits on minimal detection limits.

### SUMMARY OF THE INVENTION

This invention provides systems and methods for detection of human fat metabolism byproducts and analysis of the detection for optimizing dietary results.

The current invention includes a compact opto-electronic based sensor to significantly increase (factor of 20 or more) the accuracy and minimal detection limits for a standard ketone test strip.

### BRIEF DESCRIPTION OF THE DRAWINGS

Preferred and alternative examples of the present invention are described in detail below with reference to the following drawings:

FIG. 1 is a block diagram of an exemplary system formed in accordance with an embodiment of the present invention;

FIG. 2 shows an exemplary data set produced by the system shown in FIG. 1;

FIGS. 3a, b show an exemplary sensing cartridge formed in accordance with an embodiment of the present invention; and

FIGS. 4a, b show an exemplary metabolism sensing device formed in accordance with an embodiment of the present invention.

### DETAILED DESCRIPTION OF THE PREFERRED EMBODIMENT

Parent U.S. patent application Ser. No. 12/139,259 ('259) describes a chemical sensor that uses multiple colored light sources (e.g. LEDs) to observe changes in agent-reagent colorimetric chemical reactions taking place in an absorbing layer placed within an integrating sphere.

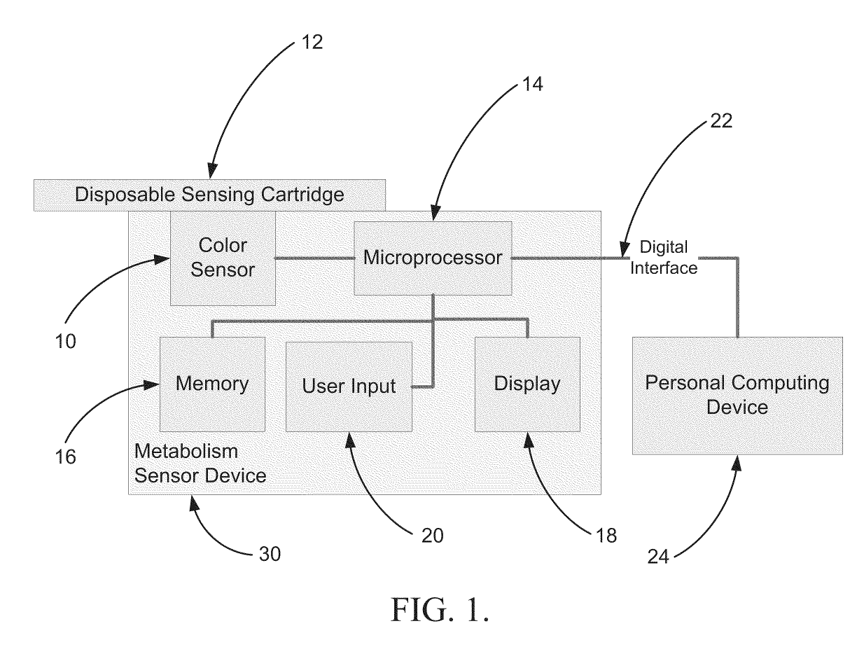

FIG. 1 is a block diagram of an embodiment of the present invention which includes a metabolism sensing device 30. The metabolism sensing device 30 includes a color sensor 10 combined with a sensing cartridge 12 in such a way as to produce the color sensor described in '259. Specifically, the color sensor 10 is physically interfaced to the sensing cartridge 12 so that the sensing cartridge 12 forms part of an absorbing layer within an integrating sphere as described in '259. As will be described in more detail later, the sensing cartridge 12 is designed to include means to apply a small urine sample that becomes the chemical agent to be tested.

The metabolism sensing device 30 includes a microprocessor 14 that performs data acquisition and control of the color sensor 10. In one embodiment, the microprocessor 14 is responsible for collecting data at specified time intervals (e.g. once per second). The microprocessor (or microcontroller) 14 includes an algorithm that processes temporal variations in the data obtained from the color sensor 10 and places a data-time stamp on that data. The microprocessor 14 stores the compendium of data, analysis results, and date-time on a non-volatile memory 16 for later use.

In one embodiment, the metabolism sensing device 30 also includes a display 18 (or comparable output device) to show test results for current measurement, past measurements, trend lines and other pertinent data. The metabolism sensing device 30 also includes a user input device (e.g. a keypad or a touch screen as part of the display device) to be used for setting time, date, initiating measurements, or recalling data.

The metabolism sensing device 30 also includes a digital interface device 22 (e.g. a USB port) for connecting a personal computing device 24 (e.g. a personal computer (PC), a smart phone, a tablet computer device, etc.) The personal computing device 24 includes software that allows a user to track results versus time, set and compare goals, develop trends, etc. in a typical graphical user interface (GUI) environment.

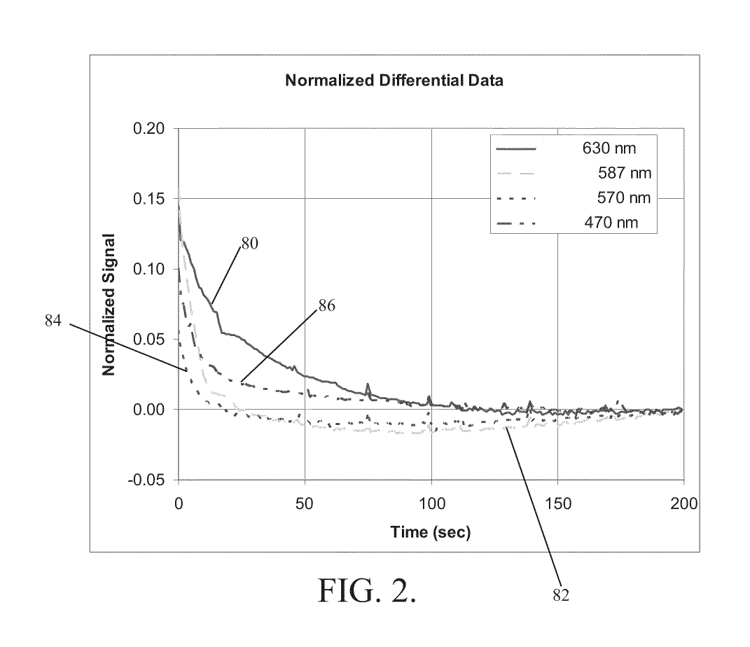

FIG. 2 shows data retrieved from an exemplary metabolism sensing device 30 in which the reagent is a nitroprusside ketone sensing strip and the agent is a urine sample with a moderate level of acetoacetate (a particular ketone) present (˜15 mg/dl). Four color channels (red 80 at 630 nanometer, yellow 82 at 587 nanometers, green 84 at 570 nanometer, blue 86 at 470 nanometer) were simultaneously measured at 1 second intervals. The data shown are fractional changes in reflection for each color channel. The shift in color in ketone strips is described by the strip manufacturer as moving towards a pinkish purple as a composite (apparent) color to the eye. The data in FIG. 2 shows that all the ‘pure’ colors are changing to give this impression. Several different time scales are clearly present in the data. The strip manufacturer's instructions are to read the color after 20 seconds. Clearly missing this time point by even a few seconds causes a significant error in the measurement.

Accurate reading of the apparent color changes is challenging without the use of the colorimetric chemical sensor followed by analysis of the chemical dynamics seen in the time sequences. Time sequence analysis can be performed by measurement of decay rates on the several color channels for known concentrations. These key signatures can then be used to fit unknown samples. Sensitivity of better than 0.25 mg/dl has been demonstrated for acetoacetate, roughly a factor of 20 better than ‘by eye’ comparisons to color charts.

Independent measurements on non-dieting, reduced calorie dieting and low carbohydrate (Atkins) dieting with the sensor indicated a ketone range of less than 3 mg/dl ketone concentrations (undistinguishable from zero for ‘by eye’ measurements), from 3 to 15 mg/dl for reduced calorie dieters with the high range being achieve for those performing heavy exercise and greater than 15 mg for low carbohydrate dieters. The normal dieting range is in the region of trace to very low for ‘by eye’ measurements according to the strip manufacturer's instructions.

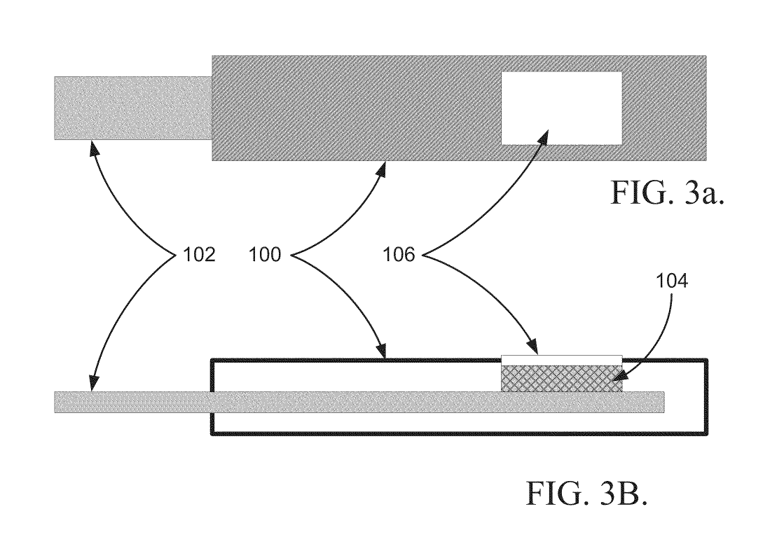

Further details of the sensing cartridge 12 are shown in FIGS. 3a and b. FIG. 3a is a top view and FIG. 3b is a cut away side view showing the internal components of the sensing cartridge 12. The sensing cartridge 12 includes a cartridge housing 100, a liquid transport body 102, an absorbing layer 104, and a transparent window 106. The sensing cartridge 12 is designed to be inexpensive, so as to disposable after use. The cartridge housing 100 would be nominally produced via plastic molding processes and laid out for accurate optical alignment when placed into the device 30. The liquid transport body 102 is designed to rapidly absorb an applied urine sample and transport the urine sample rapidly to the absorbing layer 104. Structured plastic materials such as those found in standard pregnancy test cartridges are an example of a suitable liquid transport body 102. The absorbing layer 104 contains the reagent (e.g. nitroprusside) within a matrix that will absorb urine from the liquid transport body 102 with which it is placed in direct contact. Ordinary filter paper is an exemplary base for such the absorbing layer 104. The transparent window 106 allows optical access for measuring the color changes that will occur in the absorbing layer 104 when ketone in the urine reacts with the reagent (e.g. nitroprusside) in the absorbing layer 104.

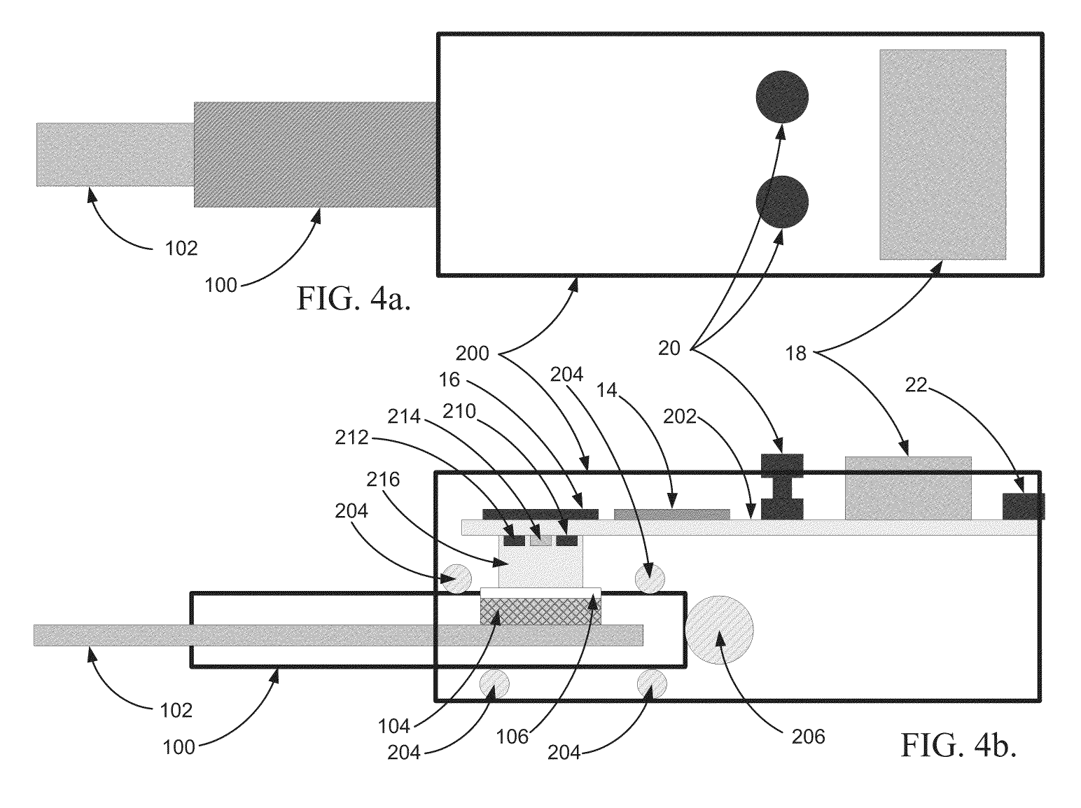

FIGS. 4a and b show an example of the sensing cartridge 12 as it is placed into the metabolism sensing device 30. FIG. 4a is a top view and FIG. 4b is a cut away side view showing the internal components. The device 30 includes a device housing 200 which includes a printed circuit board (PCB) 202 along with alignment guides 204 and an alignment stop 206. The alignment guides 204 and the alignment stop 206 are placed such that insertion of the sensing cartridge 12 forces alignment of the transparent window 106 with an optically integrating housing 216 that is attached to the PCB 202.

The PCB 202 allows mounting of integrated circuits corresponding to the microcontroller 14 and the memory 16. Of note is that some microcontrollers contain sufficient internal non-volatile memory formed as a separate integrated circuit. The display 18, such as an alpha-numeric display or a dot-matrix display, is also connected to the PCB 202. The digital interface 22 as in the form of a USB connector is mounted onto the PCB 202. Other incidental components such as capacitors, resistors, clock crystals, and power connections are added to the PCB 202 as needed for correct operation of the individual integrated circuits or display. The user interface 20 is in the form of push buttons.

A set of light sources (two shown) 210 and 212 and an optical detector 214 are placed inside the optically integrating housing 216 with all these components attached to the PCB 202. The optically integrating housing 216 is open on the end opposite the PCB 202 such that it can be placed into direct contact with the transparent window 106 of the sensing cartridge 12. This arrangement is a particular form of the optical sensor described in U.S. patent application Ser. No. 12/139,259 whereby the optically integrating housing 216, that portion of the PCB 202 contained within the housing 200 and the absorbing layer 104 produce an ‘integrating sphere’. The light sources 210 and 212 are turned on sequentially. The illumination from the light sources 210 and 212 is scattered throughout the volume contained within the ‘integrating sphere’ whereby some portion of the scattered light is absorbed in the absorbing layer 104, and that of the scattered light portion not absorbed is scattered back into the detector 214. The microcontroller 16 controls the illumination process and digitally records the response from the detector 214.

In operation, the device 30 is activated through activation of one of the push buttons 20 after introduction of the sensing cartridge 12. The user would then wet the liquid transport body 102 with a urine sample. The urine will then transport up the liquid transport body 102 until it flows into and wets the absorbing layer 104. The wetting of the absorbing layer 104 can be readily detected by sudden change in the reflectance properties of the layer. At this point data is collected by the device 30 on a regular sampling period (e.g. 1 second). The resulting data sampled at the sampling periods will look similar to that shown in FIG. 2. This data can then be analyzed as compared to calibration standards to produce an estimate of the amount of ketone present in the urine sample. Results of the test can then be shown on the display 18. The display 18 could also be used to indicate process progress. The raw data, the ketone estimate, a date-time stamp and any other useful data (e.g. a user ID) can then be stored as a data set in the memory 14. Once completed, the sensing cartridge can be disposed.

The data set stored in the memory 14 can be transferred via the digital interface 22 to the personal computing device 24 for further analysis, plotting versus time or other useful data displays. The user could also use the user input 20 to retrieve data sets stored in the memory 16 and show historical results on the display 18.

Although the current invention is directed towards detection of ketones in urine, the application can be applied to other low level metabolic byproducts for which suitable reagents can be produced is also possible as well as the application to other body fluids such as blood and saliva.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system comprising:
a sample cartridge configured to receive a body fluid; and
a housing comprising:
a light integrating device comprising:
a plurality of light sources configured to provide illuminations at two or more different ranges of frequencies; and
an optical detector configured to detect reflections at the two or more different ranges of frequencies off of a portion of the sample cartridge based on the illuminations;
an input device;
an output device;
memory; and
a processor in signal communication with the optical detector, the input device, the output device and the memory, the processor configured to:
determine if the separate reflections off of the portion of the sample cartridge indicate the presence of a predefined agent in the body fluid based on a signal received from the input device;
generate results based on the determination; and
perform at least one of store the generated results in memory or output the generated results via the output device.

2. The system of claim 1, wherein the input device comprises at least one of a button or a touch screen.

3. The system of claim 1, wherein the output device comprises a display device.

4. The system of claim 2, wherein the sample cartridge comprises:
a housing;
a liquid transport device partially inserted into the housing, the liquid transport device configured to receive the body fluid;
an absorbing layer located within the housing, the absorbing layer configured to receive body fluid from the liquid transport device; and
a viewing window configured to allow visual exposure of the absorbing layer through a side of the housing.

5. The system of claim 4, wherein the system housing comprises a printed circuit board, wherein the light integrating device, the input device, the output device, the memory and the processor are mounted on the printed circuit board.

6. The system of claim 5, wherein the light integrating device is mounted on a first side of the printed circuit board and the input device, the output device, the memory and the processor are mounted on a second side of the printed circuit board.

7. The system of claim 6, wherein viewing window mates with the light integrating device when the sample cartridge is received by the system housing.

8. The system of claim 1, wherein the light integrating device comprises an integrating sphere.

9. The system of claim 1, wherein the predefined agent comprises a ketone and the body fluid comprises urine.

10. The system of claim 1, wherein the optical detector detects reflections at a predefined time interval.

11. The system of claim 10, wherein the predefined time interval is between one half to two seconds.

12. A method comprising:
receiving a body fluid on a sample cartridge;
receiving the sample cartridge with the body fluid in a first housing;
within the light integrating device,
illuminating at least a portion of the sample cartridge at two or more different ranges of frequencies; and
detecting reflections at the two or more different ranges of frequencies off of a portion of the sample cartridge based on the illuminations;
at a processor included in the first housing,
determining if the separate reflections off of the portion of the sample cartridge indicate the presence of a predefined agent in the body fluid based on a signal received from an input device of the first housing;
generating results based on the determination; and
performing at least one of storing the generated results in a memory or outputting the generated results via an output device.

13. The method of claim 12, wherein the input device comprises at least one of a button or a touch screen, wherein the output device comprises a display device.

14. The method of claim 12, wherein receiving a body fluid on a sample cartridge comprises:
receiving the body fluid at a liquid transport device partially inserted into a second housing;
receiving the body fluid at an absorbing layer from the liquid transport device within the second housing; and
allowing viewing of the absorbing layer through a side of the second housing.

15. The method of claim 14, wherein illuminating comprises mating the sample cartridge with the light integrating device when the sample cartridge is received by the first housing.

16. The method of claim 15, wherein the light integrating device comprises an integrating sphere.

17. The method of claim 12, wherein the predefined agent comprises a ketone and the body fluid comprises urine.

18. The method of claim 12, wherein detecting reflections comprises detecting reflections at a predefined time interval.

19. The method of claim 19, wherein the predefined time interval is between one half to two seconds.
